(19) United States
(12) Patent Application Publication
(10) Pub. No.: US 2024/0213503 A1
(43) Pub. Date: Jun. 27, 2024

(54) BUNKER SYSTEM AND BUNKER STATION

(71) Applicant: A.P. Møller - Maersk A/S, Copenhagen K (DK)

(72) Inventor: Morten VEJLGAARD-LAURSEN, Copenhagen K (DK)

(21) Appl. No.: 18/557,275

(22) PCT Filed: Apr. 29, 2022
(86) PCT No.: PCT/EP2022/061435

§ 371 Date: Oct. 25, 2023

(30) Foreign Application Priority Data
Apr. 30, 2021 (DK) PA202100447

(51) Int. Cl. H01M 8/04082; B63B 17/00; B67D 9/00; H01M 8/04186; H01M 8/18

(52) U.S. Cl. CPC H01M 8/04201; B63B 17/0027; B67D 9/00; H01M 8/04186; H01M 8/188; H01M 2220/20

(57) ABSTRACT

Disclosed is a bunker system comprising a container configured to contain electrolyte for a battery system of a vessel, a charger configured to charge the electrolyte in the container, and a first port that is fluidically connectable between the container and the vessel to permit a flow of the electrolyte between the container and the vessel.

### TECHNICAL FIELD

The present invention relates to bunker systems, bunker stations, and methods of bunkering and debunkering vessels such as marine vessels.

### BACKGROUND

Vessels, such as marine vessels like container ships, consume fuel in systems of the vessel, such as in engines and propulsion systems. The fuel is stored in fuel tanks, which are often referred to as bunkers. Vessels also comprise systems that consume electrical energy, such as control systems of the vessel, heating and lighting systems, and fluid systems comprising hydraulic pumps, such as fuel systems for engines of the vessel. The electricity for such systems is typically provided by electrical power generators of the vessel, in some examples by consuming the fuel onboard, or by a power grid or external power generator, such as during a port stay.

Bunker stations are provided at ports for bunkering fuel to vessels. The bunker stations are connected to fuel storage tanks of the vessel when the vessel is docked in a port, and fuel is supplied to the fuel storage tanks from fuel reservoirs of the bunker station.

### SUMMARY

A first aspect of the present invention provides a bunker system comprising: a container configured to contain electrolyte for a battery system of a vessel; a charger configured to charge the electrolyte in the container; and a first port that is fluidically connectable between the container and the vessel to permit a flow of the electrolyte between the container and the vessel.

In this way, electrolyte may be conveniently charged at the bunker system and bunkered to the vessel, such as to quickly charge the battery system of the vessel without needing to electrically connect the battery system of the vessel to an electrical power source.

Optionally, the battery system of the vessel comprises a flow battery configured to extract electrical energy from the charged electrolyte for powering electrical systems of the vessel. In this way, the electrical systems may be powered without consuming engine fuel, thereby reducing a cost of operating the vessel, and or reducing emissions from the vessel, such as during a port stay and/or a voyage.

Optionally the charger comprises an interface configured to receive electrical energy from an electrical power source.

In this way, the charger may charge the electrolyte using the electrical energy from the power source. Optionally, the electrical power source is remote from the bunker system. Alternatively, the bunker system comprises the electrical power source.

Optionally, the electrical power source comprises a generator configured to generate the electrical energy from another type of energy. Optionally, the generator is configured to generate the electrical energy from a renewable resource, such as sunlight, wind, rain, tides, waves or geothermal heat. This may reduce a cost and/or improve an environmental impact of charging the electrolyte and, ultimately, powering electrical systems of the vessel.

Optionally, the bunker system comprises a first fluid moving device configured to move the electrolyte through the first port. The first fluid moving device may be configured to move the electrolyte through the first port from the container towards the vessel and/or configured to move the electrolyte through the first port from the vessel to the container.

Optionally, the electrolyte comprises an anolyte and a catholyte. Optionally, the container comprises a first container section configured to contain the anolyte and a second container section configured to contain the catholyte. Optionally, the first and second container sections are isolated from each other.

In this way, when charged by the charger, the anolyte may become more negatively charged and the catholyte may become more positively charged.

Optionally, the first port is fluidically connectable between the first container section and the vessel to permit a flow of the anolyte between the first container section and the vessel. Optionally, the bunker system comprises a second port that is fluidically connectable between the second container section and the vessel to permit a flow of the catholyte between the second container section and the vessel.

In this way, the anolyte and catholyte may be independently passable from the respective first and second container sections to the vessel, and/or from the vessel to the respective first and second container sections. This may avoid a mixing of charged and uncharged electrolyte.

Optionally, the bunker system comprises a second fluid moving device configured to move the electrolyte through the second port. The second fluid moving device may be configured to move the electrolyte through the second port from the container towards the vessel and/or configured to move the electrolyte through the second port from the vessel to the container.

Optionally, the bunker system comprises a flow battery that comprises the container and the charger. Optionally, the first container section comprises a first ion exchange chamber, the second container section comprises a second ion exchange chamber, and the flow battery comprises an ion exchange interface that separates the first ion exchange chamber from the second ion exchange chamber. Optionally, the charger is configured to charge the electrolyte in the first and second ion exchange chambers.

In other words, the charger is configured to provide a voltage difference across the first and second ion exchange chambers and electrolyte contained therein or passing therethrough, in use. The voltage difference may cause charged ions from the anolyte in the first ion exchange chamber to pass through the ion exchange membrane to the catholyte in the second ion exchange chamber. This may cause the anolyte to become more negatively charged and the catholyte to become more positively charged.

Optionally, the first container section comprises a first reservoir configured to store the anolyte. Optionally, the first port opens into the first reservoir. Optionally, the first reservoir is fluidically connected, or connectable, to the first ion exchange chamber. Optionally, the container comprises a first loop comprising the first reservoir and the first ion exchange chamber. Optionally, the bunker system comprises a first flow moving device configured to move the anolyte between the first reservoir and the first ion exchange chamber, such as around the first loop.

Optionally, the second container section comprises a second reservoir configured to store the catholyte. Optionally, the second port opens into the second reservoir. Optionally, the second reservoir is fluidly connectable or connected to the second ion exchange chamber. Optionally, the container comprises a second loop comprising the second reservoir and the second ion exchange chamber. Optionally, the bunker system comprises a second flow moving device configured to move the catholyte between the second reservoir and the second ion exchange chamber, such as around the second loop. In this way, the anolyte and catholyte may be gradually charged as they are repeatedly passed around the respective first and second loops.

Optionally, the bunker system comprises third and fourth reservoirs connected, or connectable, to the respective first and second ion exchange chambers. Optionally, the third and fourth reservoirs are configured to store the anolyte and the catholyte, respectively. Optionally, the first and third reservoirs are independently fluidically connected, or connectable, in respective fluid loops with the first ion exchange chamber.

Optionally, the second and fourth reservoirs are independently fluidically connected, or connectable, in respective fluid loops with the second ion exchange chamber. Optionally, the third and fourth reservoirs are fluidically connected, or connectable, to the vessel via respective third and fourth ports opening into the respective third and fourth reservoirs.

A second aspect of the present invention provides a bunker station comprising the bunker system of the first aspect.

Optionally, the bunker station is land-based. Alternatively, the bunker station is non-land-based, such as water-based, such as comprised on a bunker barge.

A third aspect of the present invention provides a bunker station comprising a bunker system, the bunker system comprising: a container containing charged electrolyte for a battery system of a vessel; and a port that is fluidically connectable between the container and the vessel to permit a flow of the charged electrolyte from the container to the vessel.

Optionally, the bunker station and/or bunker system comprises any of the optional features of the bunker system of the first aspect and or the bunker station of the second aspect. Optionally, the bunker station and/or bunker system comprises a charger configured to charge the electrolyte in the container.

A fourth aspect of the present invention provides a method of bunkering a vessel, the method comprising bunkering charged electrolyte to the vessel from a bunker station.

Optionally, the vessel comprises a flow battery configured to store electrical energy in the form of the charged electrolyte and/or extract electrical energy from the charged electrolyte for use in powering electrical systems of the vessel.

Optionally, the bunkering is performed between voyages, or during a voyage, of the vessel. Optionally, the charged electrolyte is bunkered to the vessel from a container of the bunker station. Optionally, the bunker station is one of the bunker stations discussed above.

Optionally, the method comprises connecting the vessel to the bunker station before bunkering the charged electrolyte to the vessel. Optionally, the method comprises disconnecting the vessel from the bunker station after bunkering the charged electrolyte.

Optionally, the method comprises charging electrolyte to provide the charged electrolyte, before the bunkering the charged electrolyte to the vessel. Optionally, the charged electrolyte comprises a charged anolyte and a charged catholyte, and the bunkering comprises bunkering the charged anolyte to the vessel and bunkering the charged catholyte to the vessel separately from the charged anolyte.

Optionally, the bunker station comprises the bunker system of the first aspect. Optionally, the method comprises charging, using the charger, when provided, electrolyte stored in the third and fourth reservoirs, when provided, so that charged electrolyte is stored in the third and fourth reservoirs. Optionally, the method comprises connecting the vessel to the third and fourth reservoirs via respective third and fourth ports opening into the respective third and fourth reservoirs. Optionally, the method comprises bunkering the charged electrolyte from the third and fourth reservoirs to the vessel via the respective third and fourth ports. Optionally, the method comprises charging electrolyte stored in the first and second reservoirs as the electrolyte flows through the first and second ion exchange chambers, when provided, via the respective first and second loops, when provided, before, during, or after the bunkering the charged electrolyte from the third and fourth reservoirs to the vessel. Optionally, the method of the fourth aspect is a method of bunkering and debunkering the vessel. Optionally, the method comprises connecting the vessel to the first and second reservoirs via respective first and second ports opening into the respective first and second reservoirs. Optionally, the method comprises debunkering electrolyte from the vessel to the first and second reservoirs to provide the electrolyte stored in the first and second reservoirs.

Optionally, the vessel comprises a ballast tank defining a ballast tank chamber configured to store the electrolyte, and the bunkering comprises bunkering the electrolyte to the ballast tank chamber.

Optionally, the bunker station is the bunker station according to the second aspect and/or the third aspect. Optionally, the bunker station used in the method comprises any of the optional features of the bunker station of the second aspect and/or the third aspect.

A fifth aspect of the present invention provides a method of debunkering a vessel, the method comprising debunkering used electrolyte from the vessel to a bunker station.

Optionally, the vessel comprises a flow battery configured to store electrical energy in the form of the charged electrolyte and/or extract electrical energy from the charged electrolyte for use in powering electrical systems of the vessel.

In this way, used, discharged, and/or partially discharged electrolyte on the vessel may be removed from the vessel. The debunkered electrolyte may be charged by the bunker station, such as for bunkering back to the vessel and/or to another vessel. In this way, the electrolyte may be charged without requiring the vessel to be connected to an external electrical power supply, such as during a port stay.

Optionally, the vessel comprises a ballast tank defining a ballast tank chamber configured to store the electrolyte, and the debunkering comprises debunkering the electrolyte from the ballast tank chamber to the bunker station.

In this way, the electrolyte may be used to control a stability and/or an attitude of the vessel, such as by passing the electrolyte between two or more ballast tanks to control a trim of the vessel. This may also reduce an amount of cargo space that might otherwise be taken up by storage tanks of the vessel for storing the electrolyte.

Optionally, the method comprises bunkering charged electrolyte to the vessel from the bunker station, wherein the debunkering is performed before, during, or after the bunkering the charged electrolyte to the vessel.

That is, discharged electrolyte in the vessel may be replaced, using the bunker station, with charged electrolyte. That is, the flow battery of the vessel may be quickly and efficiently recharged by debunkering discharged electrolyte from the vessel and bunkering charged electrolyte to the vessel. Optionally, the method comprises charging electrolyte to provide the charged electrolyte, before the bunkering the charged electrolyte to the vessel. That is, the bunker system may charge the electrolyte that has been debunkered from the vessel, or electrolyte from any other source, such as another vessel.

Optionally, the bunker station comprises the bunker system of the first aspect. Optionally, the method comprises connecting the vessel to the first and second reservoirs via respective first and second ports opening into the respective first and second reservoirs. Optionally, the method comprises debunkering the electrolyte from the vessel to the first and second reservoirs via the respective first and second ports. Optionally, the method comprises charging the electrolyte stored in the first and second reservoirs as the electrolyte flows through the first and second ion exchange chambers, when provided, via the respective first and second fluid loops, when provided. Optionally, the method comprises charging, using the charger, electrolyte stored in the third and fourth reservoirs, when provided, before during, or after the debunkering the charged electrolyte from the vessel to the first and second reservoirs. Optionally, the method of the fifth aspect is a method of debunkering and bunkering the vessel, and the method comprises bunkering the charged electrolyte from the third and fourth reservoirs to the vessel via the respective third and fourth ports. Optionally, the bunkering the charged electrolyte from the third and fourth reservoirs to the vessel comprises connecting the vessel to the third and fourth reservoirs via respective third and fourth ports opening into the respective third and fourth reservoirs.

Optionally, the vessel is a marine vessel, such as a container ship. Optionally, the bunker station is the bunker station according to the second aspect and/or the third aspect. Optionally, the bunker station used in the method comprises any of the optional features of the bunker station of the second aspect and/or the third aspect.

A sixth aspect of the present invention provides a bunker system comprising: a container configured to contain electrolyte for a battery system of a vessel; electrodes that are configured to pass electrical energy to the electrolyte in the container to charge the electrolyte in the container; and a first port that is fluidically connectable between the container and the vessel to permit a flow of the electrolyte between the container and the vessel.

The bunker system may comprise any of the optional features of the bunker system of the first aspect. Optionally, the bunker system comprises a charger configured to charge the electrolyte in the container, and the charger comprises the electrodes. Optionally, the bunker station of the second aspect comprises the bunker system of the sixth aspect.

A seventh aspect of the present invention provides a bunker vessel comprising the bunker system of the first aspect or the sixth aspect, or the bunker station of the second aspect or the third aspect.

In this way, the bunker vessel may be used to bunker and/or debunker electrolyte to and/or from a vessel during a voyage of the vessel. The bunker vessel may also be configured to bunker and/or debunker fuel for the vessel during the voyage of the vessel, such as before, after and/or at the same time as bunkering and/or debunkering the electrolyte. That is, the bunker vessel may advantageously be used to refuel the vessel and recharge a flow battery of the vessel during a voyage of the vessel. The bunker vessel may be a bunker barge.

### BRIEF DESCRIPTION OF THE DRAWINGS

Embodiments of the invention will now be described, by way of example only, with reference to the accompanying drawings, in which:

FIG. 1 shows a schematic diagram of an example of a marine vessel connected to a bunker station;

FIG. 2 shows a schematic view of an example of a battery system of a bunkering station;

FIG. 3 shows a schematic view of example connections between storage tanks of a marine vessel and reservoirs of a bunker station; and

FIG. 4 shows a flow diagram of a method according to an example.

### DETAILED DESCRIPTION

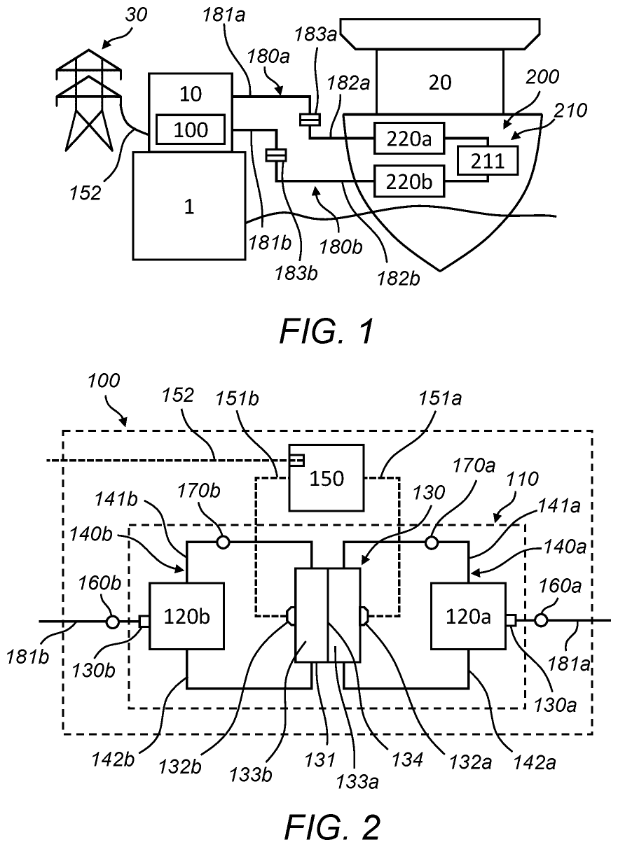

FIG. 1 shows a schematic view of an example of a vessel 20 docked at a port 1 according to an example of the present invention. In this example, the vessel is a marine vessel, specifically a container ship 1. In other examples, the marine vessel is another form of cargo vessel, such as a tanker, a dry-bulk carrier or a reefer ship, a passenger vessel, a tugboat, or any other marine vessel. In other examples the vessel 20 is other than a marine vessel, such as a riverboat.

The marine vessel 20 comprises a battery system 200 comprising a vessel flow battery 210, the vessel flow battery 210 comprising an ion exchange element 211, a first storage tank 220a and a second storage tank 220b for storing electrolyte for the vessel flow battery 210. As will be described in more detail hereinafter, the vessel flow battery 210 is configured to store electrical energy in the form of a charged electrolyte, and to generate electricity by electrically discharging the charged electrolyte using the ion exchange element 210. In the present example, the storage tanks 220a, 220b are first and second ballast tanks 220a, 220b of the marine vessel 20, such as comprised in a hull 21 of the vessel. The first and second ballast tanks 220a, 220b define respective first and second ballast tank chambers (not shown) for storing the electrolyte. In other examples, the storage tanks 220a, 220b are other than ballast tanks, such as storage tanks located in any other suitable location in the vessel 20.

The port 1 comprises a bunker station 10 comprising a bunker system 100. The bunker station 10 in the illustrated example is land-based. In other examples, the bunker station 10 is non-land based, such as water-based, such as comprised in a bunker vessel. In such an example, the element numbered 1 in FIG. 1 is to be considered the bunker vessel, rather than a port.

FIG. 2 shows a schematic diagram of an example of the bunker system 100. The bunker system 100 comprises a first reservoir 120a and a second reservoir 120b containing, and/or configured to contain, electrolyte for the vessel flow battery 210 of the vessel 20. The bunker system 100 also comprises first and second ports 130a, 130b that are each fluidically connected, or connectable, between the respective first and second reservoirs 120a, 120b and the vessel 20, specifically the respective first and second storage tanks 220a, 220b of the vessel 20. This is to permit a flow of electrolyte between the first and second reservoirs 120a, 120b and the respective first and second storage tanks 220a, 220b. The bunker system also comprises a station flow battery 110 comprising the first and second reservoirs 120a, 120b and a charger 130 for charging the electrolyte in the reservoirs 120a, 120b, as will be described in more detail hereinafter.

The bunker station 10, in other words, can be used to bunker electrolyte, such as charged electrolyte stored in the reservoirs 120a, 120b, to the vessel 20, such as to the respective first and second storage tanks 220a, 220b. Similarly, the bunker station 10 can be used to debunker electrolyte, such as discharged, or partially discharged electrolyte, from the vessel 20 to the bunker system 100. Specifically, the bunker station 10 may be configured to debunker electrolyte from the first and second storage tanks 220a, 220b to the respective first and second reservoirs 120a, 120b. The station flow battery 110 can then be used to charge the electrically discharged electrolyte received from the vessel 20, such as for re-bunkering to the vessel 20 or bunkering to another vessel.

The fluidic coupling between the bunker station 10 and the vessel 20 is now described in more detail with reference to FIGS. 1 and 2.

As best shown in FIG. 1, in the present example, the bunker station 10 and the vessel 20 are fluidically connected, or connectable, to each other by first and second bunker conduits 180a, 180b. Specifically, the first and second bunker conduits 180a, 180b are fluidically connected, or connectable, via the respective first and second ports 130a, 130b, between the respective first and second reservoirs 120a, 120b and the respective first and second storage tanks 220a, 220b of the vessel 20.

The first and second bunker conduits 180a, 180b each comprise respective first and second station conduits 181a, 181b, which may be pipes such as flexible pipes, and respective first and second vessel conduits 182a, 182b, which may be pipes such as rigid pipes. The first and second station conduits 181a, 181b are parts of the bunker system 100, and may comprise, or be fluidically connected or connectable to, the respective first and second ports 130a, 130b. The first and second vessel conduits 182a, 182b are comprised in the vessel 20, and are fluidically connected, or connectable, to the respective first and second ballast tanks 220a, 220b. The first and second station conduits 181a, 181b are fluidically connected, or connectable, to the respective first and second vessel conduits 182a, 182b by respective first and second bunker connections 183a, 183b, to form the first and second bunker conduits 180a, 180b. The first and second bunker connections 183a, 183b may be located on a deck of the vessel 20. Their illustrated position between the vessel 20 and the bunker station 10 is merely schematic and for the purpose of clarity.

In some examples, the first and second bunker connections 183a, 183b are each comprised in, define, and/or are connectable to a vessel bunker manifold of the vessel 20. Such a vessel bunker manifold may comprise an arrangement of valves and conduits configured to receive electrolyte from the bunker station 10 and distribute the electrolyte to the storage tanks 220a, 220b and/or other storage tanks of the vessel 20, such as other storage tanks not shown in FIG. 1. It will be appreciated that the bunker manifold may similarly receive electrolyte from the storage tanks 220a, 220b and/or other storage tanks of the vessel 20 and pass the electrolyte towards the bunker system 100, such as in a debunkering process.

In some examples, the bunker system 100 comprises a distributor (not shown). The distributor may comprise, and/or may be connectable to, the first and second station conduits 181a, 181b. The distributor may be configured to receive electrolyte from the vessel 20, such as in a debunkering process, and distribute the electrolyte to the reservoirs 120a, 120b and/or other containers of the bunker system 100, such as other reservoirs and/or containers not shown in FIG. 2. It will be appreciated that the distributor may similarly receive electrolyte from the reservoirs 120a, 120b and/or other containers or reservoirs of the bunker system 100 and pass the electrolyte towards the vessel 20, such as in a bunkering process.

The bunker system 100 is now described in more detail with reference to FIG. 2. In the illustrated example, the bunker system 100 comprises a first and bunker pump 160a and a second bunker pump 160b, or other suitable fluid moving devices, configured to move the electrolyte through the respective first and second ports 130a, 130b. Specifically, the first and second bunker pumps 160a, 160b are configured to move the electrolyte through the respective first and second ports 130a, 130b from the respective first and second reservoirs 120a, 120b towards the vessel 20, and/or from the vessel 20 towards the respective first and second reservoirs 120a, 120b. That is, the first and second bunker pumps 160a, 160b are each independently reversible, to cause electrolyte to flow in either direction through the respective first and second bunker pumps 160a, 160b either towards the vessel 20 or towards the bunker system 100. In other examples, the first and second bunker pumps 160a, 160b are comprised elsewhere, such as in the vessel 20, and/or in the respective first and second bunker conduits 180a, 180b.

The flow battery 110 of the bunker system 100 of this example comprises a charger 130 comprising an ion exchange element 131 and first and second ion exchange chambers 133a, 133b in the ion exchange element 131. The first and second ion exchange chambers 133a, 133b are configured to receive, contain, and/or permit passage of the electrolyte therein. The charger 130 also comprises first and second electrodes 132b, 132a, which are electrically connected, or connectable, to the respective first and second ion exchange chambers 133a, 133b or electrolyte contained therein in use.

The charger 130 is connectable, via the first and second electrodes 132a, 132b, and respective first and second electrical connections 151a, 151b, to an electrical interface 150, which is in turn connected, or connectable, to a power supply 30 (see FIG. 1), or “power source” 30, such as an electrical grid 30, by a power supply line 152. That is, the electrical interface 150 is configured to receive electrical energy from the power supply 30. The electrical interface 150, in some examples, is configured to convert an electrical current received from the power supply 30 into an electrical current suitable for charging the electrolyte in the charger 130.

In some examples, the charger 130 comprises the electrical interface 150. In some such examples, the charger 130 comprises only (or consists of) the electrical interface 150 and the first and second electrodes 132a, 132b. It will be appreciated that, in other examples, the charger may comprise only the first and second electrodes 132a, 132b, or any other electrical connection for charging electrolyte in the ion exchange element 131. In some examples, the discrete electrical interface 150 is not present, and the first and second electrodes 151a, 151b are electrically connected to the power supply 30 in any other suitable way. In this case, the first and second electrodes 151a, 151b may be considered to define the electrical interface.

The power supply 30, as best shown in FIG. 1, is an external power supply 30, or power source 30, remote from the bunker system 100, the bunker station 10, and/or the port 1. In other examples, the power supply 30 is any other suitable power supply 30. In some examples, the bunker system 100 comprises the electrical power supply 30. In some examples, the power supply 30 comprises a generator configured to generate the electrical energy received by the electrical interface 150 from another type of energy, such as fuel energy or chemical energy. In some examples, the generator is configured to generate the electrical energy from a renewable source, such as sunlight, wind, raid, tides, waves or geothermal heat. In this way, the bunker system 100 may be operated at a reduced financial and/or environmental cost.

Returning now to FIG. 2, the first and second ion exchange chambers 133a, 133b are fluidically connected, or connectable, to the respective first and second reservoirs 120a, 120b. More specifically, the flow battery 110 of the bunker system 100 comprises first and second fluid loops 140a, 140b, and the first and second fluid loops 140a, 140b comprise the respective first and second reservoirs 120a, 120b and respective first and second ion exchange chambers 133a, 133b.

Specifically, the first fluid loop 140a comprises a first feed conduit 141a fluidically connected, or connectable, between the first reservoir 120a and the first ion exchange chamber 133a. The first fluid loop 140a also comprises a first return conduit 142a fluidically connected, or connectable, between the first reservoir 120a and the first ion exchange chamber 133a. The first loop 140a also comprises a first loop pump 170a, or other fluid moving device, configured to move electrolyte around the first fluid loop 140a from the first reservoir 120a to the first ion exchange chamber 133a via the first feed conduit 141a and from the first ion exchange chamber 133a to the first reservoir 120a via the first return conduit 142a. The first loop pump 170a is reversible, to cause the electrolyte to flow in either direction around the first fluid loop 140a. In some examples, the first loop pump 170a may be located in any other suitable location, such as in the first return conduit 1a.

The second fluid loop 140b is of a similar construction to the first fluid loop 140a, and comprises a second feed conduit 141b fluidically connected, or connectable, between the second reservoir 120b and the second ion exchange chamber 133b. The second fluid loop 140b also comprises a second return conduit 142b fluidically connected, or connectable, between the second reservoir 120b and the second ion exchange chamber 133b. The second loop 140b also comprises a second loop pump 170b, or other fluid moving device, configured to move electrolyte around the second fluid loop 140b from the second reservoir 120b to the second ion exchange chamber 133b via the second feed conduit 141b and back to the second reservoir 120b via the second return conduit 142b. The second loop pump 170b is reversible, to cause the electrolyte to flow in either direction around the second fluid loop 140b. In some examples, the second loop pump 170b may be located in any other suitable location, such as in the second return conduit 142b.

The first and second ion exchange chambers 133a, 133b are separated from each other by an ion exchange interface 134. In the present example, the ion exchange interface 134 is an ion exchange membrane 134 configured to permit electrically charged ions to flow from an electrolyte in one of the first and second ion exchange chambers 133a, 133b to an electrolyte in the other of the first and second ion exchange chambers 133a, 133b, in use. In other examples, the ion exchange interface 134 is a fluid-fluid interface between two electrolytes flowing in a laminar flow regime through the ion exchange element 131.

In the illustrated example, the first reservoir 120a comprises a positively charged electrolyte, or a “catholyte”, in use, and the second reservoir 120b comprises a negatively charged electrolyte, or an “anolyte”, in use. In other examples, the first reservoir 120a comprises an anolyte and the second reservoir 120b comprises a catholyte, in use. In some examples, the first and second reservoirs 120a, 120b comprise electrolyte with a low, or no, electrical charge, in use. That is, in some examples, the anolyte and catholyte have a low, or no electrical charge.

The catholyte stored in the station flow battery 110 is flowable through one of the first and second ion exchange chambers 133a, 133b, such as via a respective one of the first and second fluid loops 140a, 140b, and the anolyte stored in the flow battery 110 is flowable through the other of the first and second ion exchange chambers 133a, 133b, such as via the other of the first and second fluid loops 140a, 140b. As the electrolytes flow in the respective first and second ion exchange chambers 133a, 133b, in use, a voltage difference is applied across the charger 130, via the first and second electrodes 132a, 132b, which are each in electrical contact with one of the anolyte and catholyte in the ion exchange element. That is, each of the first and second electrodes 132a, 132b is either an anode or a cathode, depending on whether it is in contact with the anolyte or the catholyte in use. The voltage difference applied across the ion exchange element 131 causes charged ions from the respective electrolytes to be exchanged across the ion exchange interface 134. The exchange of charged ions across the ion exchange interface 134 causes the anolyte to become more negatively charged and the catholyte to become more positively charged. Thereby, the flow battery 110 stores electrical energy in the form of the charged electrolyte stored in the first and second fluid reservoirs 120a, 120b.

It will be appreciated that the flow battery 110, and specifically the charger 130, may instead be electrically connected to an electrical load as the electrolyte is passed in the respective first and second fluid loops 140a, 140b, thereby to discharge the electrolyte and generate electrical energy to be supplied to the electrical load. Indeed, the vessel flow battery 210 has a similar construction to the station flow battery 110, in that the vessel flow battery 210 comprises a vessel ion exchange element 211 fluidically connected, or connectable, in respective fluid loops with the respective first and second storage tanks 220a, 220b. The ion exchange element 211 is electrically connected, or connectable, to an electrical system of the vessel 20, such as a heating system, a lighting system, a propulsion system, an air conditioning system, and/or a control system. In this way, the vessel battery system 200 is able to supply electrical energy stored in positively and negatively charged electrolyte in the first and second storage tanks 220a, 220b to the electrical system.

In this example, the electrolyte stored in the first and second reservoirs 120a, 120b (and/or the first and second storage tanks 220a, 220b) in use comprises vanadium, such as vanadium in a solution of sulfuric acid. As such, each of the first and second reservoirs comprises an electrically insulative interior defining respective first and second reservoir chambers (not shown) for storing the electrolyte. This may reduce a risk of an electrical charge being developed between the electrolyte and the interiors of the respective first and second reservoirs 120a, 120b, and/or to reduce a risk of corrosion of the interiors of the respective first and second reservoirs 120a, 120b. In the present example, the electrically insulative interiors of the respective first and second reservoirs 120a, 120b are polymeric interiors. Specifically, each of the first and second reservoirs 120a, 120b is constructed of a polymeric material. In other examples, each of the first and second reservoirs 120a, 120b is constructed of any other suitable material and comprises an electrically insulative interior coating, such as an epoxy-based coating. It will be understood that the storage tanks 220a, 220b of the marine vessel 20 may have a similar construction to the first and second reservoirs 120a, 120b of the bunker station 10. In other examples, the electrolyte is any other suitable electrolyte for a flow battery, such as a zinc and/or a bromine-based electrolyte.

It will be appreciated from the foregoing description that the bunker system 100 is able to charge an electrolyte using the charger 130, store the charged electrolyte in the first and second reservoirs 120a, 120b, and bunker the charged electrolyte to the vessel 20 via the first and second ports 130a, 130b. In this way, the bunker station 10 may be used to “charge” the vessel flow battery 210 of the vessel 20, such as without needing to connect the battery system 200 to a power supply.

In other examples, the electrolyte is charged offsite, such as at a location remote from the bunker station 10 and/or the port 1, and is transported to the bunker station 10 and/or port 1. That is, the electrolyte may be transported using a truck, such as a tanker truck, or in individual storage tanks on any other truck. In other examples, the remotely charged electrolyte may be transferred to the bunkering station 10 using any suitable pipe network. In some such examples, the port 1 may comprise one or more centralised flow batteries for charging electrolyte, and the charged electrolyte is passed to plural bunker stations 10 of the port 1. In some such examples, the bunker station 10 may not comprise the charger 130. For example, the bunker station 10 may comprise reservoirs, such as the first and second reservoirs 120a, 120b configured to store the already-charged electrolyte for bunkering to the vessel 20.

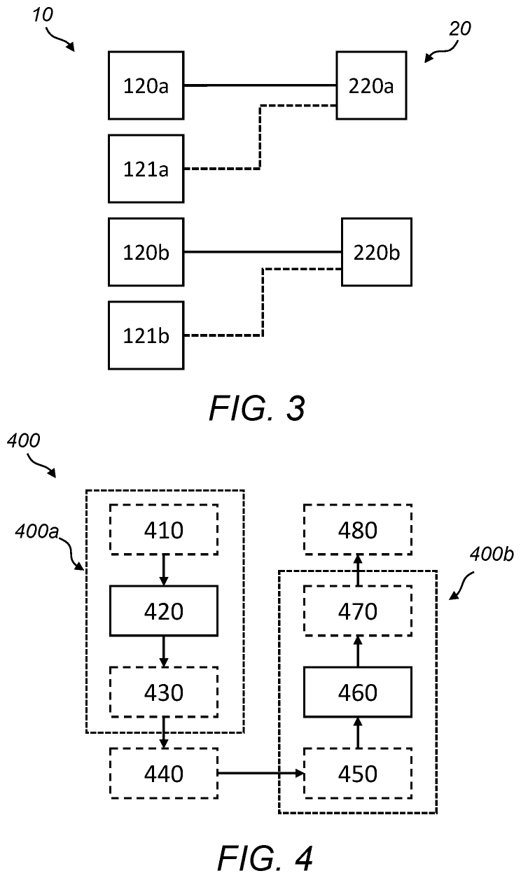

In an alternative example, as shown in FIG. 3, the bunker station 10, and specifically the bunker system 100, comprises the first and second reservoirs 120a, 120b and third and fourth reservoirs 121a, 121b. Although not shown here, the third and fourth reservoirs 121a, 121b are connected, or connectable, to the respective first and second ion exchange chambers 133a, 133b of the flow battery 110. In some such examples, the first and third reservoirs 120a, 121a are independently fluidically connected, or connectable, in respective fluid loops with the first ion exchange chamber 133a, such as via any suitable arrangement of conduits and/or valves. That is, in some examples, the third reservoir 121a is fluidically connected, or connectable, in a third fluid loop with the first ion exchange chamber 133a. The second and fourth reservoirs 120b, 121b may be independently fluidically connected, or connectable, to the second ion exchange chamber 133b in a similar way. That is, in some examples, the fourth reservoir 121b is fluidically connected, or connectable, in a third fluid loop with the first ion exchange chamber 133a. In this way, electrolyte in the first and second reservoirs 120a, 120b may be charged, or simply stored, while electrolyte in the third and fourth reservoirs 121a, 121b is bunkered and/or debunkered to/from the vessel 20. Alternatively, electrolyte in the third and fourth reservoirs may be charged, or simply stored, while electrolyte in the first and second reservoirs is bunkered and/or debunkered to/from the vessel 20 in any suitable way.

This process is described in more detail with reference to an example method 400 of bunkering and/or debunkering the vessel 20, which is shown as a flow chart in FIG. 4. The method 400 comprises connecting 410 the vessel 20, specifically the first and second storage tanks 220a, 220b, to the bunker station 10, specifically to the first and second reservoirs 120a, 120b. The connecting 410 may be done in any suitable way as described hereinbefore, such as using the first and second bunker conduits 180a, 180b. The resulting connections are shown as solid connecting lines in FIG. 3.

The method 400 comprises debunkering 420 electrolyte stored in the first and second storage tanks 220a, 220b, such as discharged or partially discharged electrolyte, to the respective first and second reservoirs 120a, 120b. The first and second fluid reservoirs may be initially empty, or may comprise some charged and/or partially charged electrolyte.

The method 400 then comprises disconnecting 430 the first and second storage tanks 220a, 220b from the first and second reservoirs 120a, 120b.

In some examples, the method 400 comprises charging 440 electrolyte stored in the third and fourth reservoirs 121a, 121b, such as by using the charger 130 as described hereinbefore. It will be appreciated that, in some examples, the charging 440 the electrolyte in the third and fourth reservoirs 121a, 121b may be performed at any time before, during, or after any of the actions labelled 410, 420 and 430 in FIG. 4. The charging 440 the electrolyte results in electrically charged electrolyte being stored in the third and fourth reservoirs 121a, 121b. Specifically, one of the third and fourth reservoirs 121a, 121b contains a positively charged electrolyte, and the other of the third and fourth reservoirs 121a, 121b contains a negatively charged electrolyte.

The method 400 further comprises connecting 450 the vessel 20, specifically the first and second storage tanks 220a, 220b, which may now be at least partially empty, to the bunker station 10, specifically to the third and fourth reservoirs 121a, 121b. The connecting 450 the vessel 20 to the third and fourth reservoirs 121a, 121b is done in any suitable way, as described hereinbefore, such as using the first and second bunker conduits 180a, 180b. That is, in some examples, the first and second bunker conduits 180a, 180b are connectable to the third and fourth reservoirs 121a, 121b, such as via respective third and fourth ports (not shown) opening into the respective third and fourth reservoirs 121a, 121b. The resulting connections are shown with dashed connecting lines in FIG. 3.

The method 400 comprises bunkering 460 the electrically charged electrolyte from the bunker station 10 to the vessel 20, specifically from the third and fourth reservoirs 121a, 121b to the respective first and second storage tanks 220a, 220b. In this way, the battery system 200 of the vessel 20 is charged by receiving charged electrolyte during the bunkering 460.

Finally, the method 400 comprises disconnecting 470 the first and second storage tanks 220a, 220b from the third and fourth reservoirs 121a, 121b.

In some examples, the method 400 comprises charging 480 electrolyte stored in the first and second reservoirs 120a, 120b, such as by using the charger 130 as described hereinbefore. It will be appreciated that, in some examples, the charging 480 the electrolyte in the first and second reservoirs 120a, 120b may be performed at any time before, during, or after any of the actions labelled 450, 460 and 470 in FIG. 3. The charging 480 the electrolyte results in electrically charged electrolyte being stored in the first and second reservoirs 120a, 120b. Specifically, following the charging 480, one of the first and second reservoirs 120a, 120b contains a positively charged electrolyte, and the other of the first and second reservoirs 120a, 120b contains a negatively charged electrolyte.

It will be appreciated that the method 400 comprises two main processes, which may be performed independently of each other. That is, in some examples, the method 400 is a method 400a of debunkering the vessel 20, the method 400a comprising the actions labelled 410, 420 and 430 in FIG. 4. In other examples, the method 400a of debunkering the vessel 410 also comprises the “charging” action labelled 480 in FIG. 4. In other examples, the method 400a of debunkering the vessel may comprise only the action labelled 420 in FIG. 5.

In other examples, the method 400 is a method 400b of bunkering the vessel 20, the method 400b comprising the actions labelled 450, 460 and 470 in FIG. 4. In other examples, the method 400b of bunkering the vessel 410 also comprises the “charging” action labelled 440 in FIG. 4. In other examples, the method 400b of bunkering the vessel may comprise only the action labelled 460 in FIG. 4.

It will be appreciated that the arrangement shown in FIG. 3 and/or the method 400 described with reference to FIG. 4 may be achieved in any other suitable way. For instance, in some examples, the method 400 may comprise debunkering 420 electrolyte from the vessel 10 to the first and second reservoirs 120a, 120b, charging 480 the electrolyte in the first and second reservoirs 120a, 120b, and bunkering 460 the charged electrolyte in the first and second reservoirs 120a, 120b to the vessel 20. In some such examples, the third and fourth reservoirs 121a, 121b may not be present.

In other examples, the flow battery 110 may be first flow battery 110, and the bunker system 100 may comprise a second flow battery comprising a second ion exchange element (not shown). In some such examples, the third and fourth reservoirs 121a, 121b are instead comprised in the second flow battery and/or are connected, or connectable, to the second ion exchange element. In some examples, the bunker system 100 comprises any number of flow batteries and respective reservoirs.

In some examples, the battery system 100 is a first battery system 100, and the bunker station 10 comprises a second battery system 100. In some such examples, the first battery system 100 comprises the first flow battery and the second battery system comprises the second flow battery.

In other examples, the bunker station 10 comprises a single flow battery 110, such as the flow battery 110 described hereinbefore with reference to FIG. 2, and the third and fourth reservoirs 121a, 121b are fluidically connected, or connectable, to the first and second reservoirs 120a, 120b. In this way, electrolyte in the first and second reservoirs 120a, 120b that has been charged by the charger 130 may be passed to the third and fourth reservoirs 121a, 121b for storage. That is, the third and fourth reservoirs 121a 121b may be for longer-term storage of charged electrolyte, backup storage of charged electrolyte, and/or to increase the storage capacity of the bunker station.

It will be appreciated that any two or more of the above described examples may be combined, and/or that any of the features of one example may be combined with any of the features of one or more other examples, in any suitable way.

Additionally, examples of the present invention have been discussed with particular reference to the examples illustrated. It will be appreciated that variations and modifications may be made to the examples described within the scope of the invention as defined by the appended claims.

1. A bunker system comprising:
a container configured to contain electrolyte for a battery system of a vessel;
a charger configured to charge the electrolyte in the container; and
a first port that is fluidically connectable between the container and the vessel to permit a flow of the electrolyte between the container and the vessel.

2. The bunker system of claim 1, the charger comprising an interface configured to receive electrical energy from an electrical power source.

3. The bunker system of claim 1, wherein the electrolyte comprises an anolyte and a catholyte; and
wherein the container comprises a first container section configured to contain the anolyte and a second container section configured to contain the catholyte, and wherein the first and second container sections are isolated from each other.

4. The bunker system of claim 3, wherein the first port is fluidically connectable between the first container section and the vessel to permit a flow of the anolyte between the first container section and the vessel; and
wherein the bunker system comprises a second port that is fluidically connectable between the second container section and the vessel to permit a flow of the catholyte between the second container section and the vessel.

5. The bunker system of claim 3, comprising a flow battery that comprises the container and the charger;
wherein the first container section comprises a first ion exchange chamber, the second container section comprises a second ion exchange chamber, and the flow battery comprises an ion exchange interface that separates the first ion exchange chamber from the second ion exchange chamber; and
wherein the charger is configured to charge the electrolyte in the first and second ion exchange chambers.

6. The bunker system of claim 5, wherein the first container section comprises a first reservoir configured to store the anolyte, the second container section comprises a second reservoir configured to store the catholyte, and the container comprises a first loop comprising the first reservoir and the first ion exchange chamber, and a second loop comprising the second reservoir and the second ion exchange chamber.

7. The bunker system of claim 6 comprising third and fourth reservoirs connected, or connectable, to the respective first and second ion exchange chambers.

8. The bunker system of claim 7, wherein the first and third reservoirs are independently fluidically connected, or connectable, in respective fluid loops with the first ion exchange chamber, and wherein the second and fourth reservoirs are independently fluidically connected, or connectable, in respective fluid loops with the second ion exchange chamber.

9. The bunker system of claim 8, wherein the first port opens into the first reservoir, and the second port opens into the second reservoir,

10. The bunker system of claim 9, wherein the third and fourth reservoirs are fluidically connected, or connectable, to the vessel via respective third and fourth ports opening into the respective third and fourth reservoirs.

11. A bunker station comprising a bunker system, the bunker system comprising:
a container containing charged electrolyte for a battery system of a vessel; and
a port that is fluidically connectable between the container and the vessel to permit a flow of the charged electrolyte from the container to the vessel.

12. A method of bunkering a vessel, the method comprising bunkering charged electrolyte to the vessel from a bunker station.

13. The method of claim 12, wherein the bunker station comprises the battery system of claim 7, and wherein the method comprises:
charging, using the charger, electrolyte stored in the third and fourth reservoirs so that charged electrolyte is stored in the third and fourth reservoirs;
connecting the vessel to the third and fourth reservoirs via respective third and fourth ports opening into the respective third and fourth reservoirs;
bunkering the charged electrolyte from the third and fourth reservoirs to the vessel via the respective third and fourth ports; and
charging electrolyte stored in the first and second reservoirs as the electrolyte flows through the first and second ion exchange chambers via the respective first and second loops before, during, or after the bunkering the charged electrolyte from the third and fourth reservoirs to the vessel.

14. The method of claim 13, wherein the method is a method of bunkering and debunkering the vessel, and the method comprises:
debunkering electrolyte from the vessel to the first and second reservoirs to provide the electrolyte stored in the first and second reservoirs.

15. The method of claim 12, wherein the method comprises charging electrolyte to provide the charged electrolyte, before the bunkering the charged electrolyte to the vessel.

16. A method of debunkering a vessel, the method comprising debunkering used electrolyte from the vessel to a bunker station.

17. The method of claim 16, wherein the bunker station comprises the bunker system of claim 7, and wherein the method comprises:
connecting the vessel to the first and second reservoirs via respective first and second ports opening into the respective first and second reservoirs;
debunkering the electrolyte from the vessel to the first and second reservoirs via the respective first and second ports;
charging the electrolyte stored in the first and second reservoirs as the electrolyte flows through the first and second ion exchange chambers via the respective first and second loops; and
charging, using the charger, electrolyte stored in the third and fourth reservoirs before, during, or after the debunkering the charged electrolyte from the vessel to the first and second reservoirs.

18. The method of claim 16, comprising bunkering charged electrolyte to the vessel from the bunker station, wherein the debunkering is performed before, during, or after the bunkering the charged electrolyte to the vessel.
